(19) United States
(12) Patent Application Publication
(10) Pub. No.: US 2025/0153184 A1
(43) Pub. Date: May 15, 2025

(54) RACK FOR BIOLOGICAL SAMPLE VIALS AND/OR CRYOTUBES

(71) Applicant: DREAMPATH DIAGNOSTICS, Strasbourg (FR)

(72) Inventors: Pablo JORDAN NAVAS, Madrid (ES); Valerie WILHELM, Eschau (FR)

(21) Appl. No.: 18/892,373

(22) Filed: Sep. 21, 2024

(30) Foreign Application Priority Data
Nov. 9, 2023 (FR) 2312179

(51) Int. Cl. B01L 9/06

(52) U.S. Cl. CPC B01L 9/06; B01L 2200/025; B01L 2200/14; B01L 2300/021

(57) ABSTRACT

The rack for biological sample vials and/or cryotubes includes a peripheral wall with an upper edge defining an access opening to the internal volume of the rack. There is at least one row of housings inside the internal volume. Each housing is adapted to accommodate a biological sample vial and/or cryotube. The housings are delimited by a lower face and surmounted by a side wall. There is a base connected to the peripheral wall. An axis of the housings forms an angle α of between 30 degrees and 50 degrees with the base.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to the field of equipment for the handling and automated traceability of medical samples.

### 2. Description of Related Art Including Information Disclosed Under 37 CFR 1.97 and 37 CFR 1.98

The object of the invention is a rack for biological sample vials and/or cryotubes, comprising a peripheral wall whose upper edge defines an access opening to the internal volume of the rack, inside which extends at least one row of housings of axis X each suitable for housing a biological sample vial or cryotube, said housings being delimited by a lower face, perpendicular to the axis X, surmounted by a side wall having a hollow face oriented toward the access opening to the internal volume.

Conventionally, when such vials and cryotubes are implemented, they are fitted with means of identifying the biological samples they contain, which can advantageously take the form of encoded data affixed to a label stuck by an operator to their outer wall. These identification data are then read by appropriate reading means connected to computer processing means, providing medical staff with rapid access to the corresponding patient file, previously stored in a database.

In addition, as vials and cryotubes are prepared for sampling operations, it is customary to place them in appropriate containers or racks, enabling their storage and transportation between different work areas, in a grouped manner, while limiting the risk of spillage.

In this respect, various models of racks are available on the market and are currently used in anatomy pathology and molecular biology laboratories.

Some take the form of simple bins or baskets wherein the vials and/or cryotubes are stored haphazardly, exposing them to shocks and the risk of material leaking out in the event of a poorly-closed lid or the appearance of a crack.

Other, more elaborate, designs conventionally feature a plurality of individual housings extending perpendicularly from a base, possibly forming columns and rows. They can be distinguished from one another mainly by their general appearance and the material from which they are made. Some commonly used plastic models thus comprise individual housings shaped to complement a given format of biological sample vials and/or cryotubes. There are also racks in the form of openwork baskets, made of metal wire delimiting individual housings large enough to accommodate, if required, vials and/or cryotubes of different sizes on the same rack.

In addition, regardless of the type of rack used, and in view of the growing volume of biological samples to be managed, analysis laboratories are currently obliged to implement a reliable traceability solution for vials and cryotubes, enabling them to know their location reliably at all times, and thus to be able to find each of them quickly, several times throughout the diagnostic chain. Additionally, traceability solutions are also designed to avoid potential errors in the management of vials and cryotubes, which could lead to the premature destruction of samples for which no diagnosis has yet been made.

Conventionally, such a traceability solution consists in recording the location data of such a vial or cryotube, in association with its identification data, preferably on a computerized recording medium. These data are defined by at least one identification code for the rack on which the vial or cryotube is stored, supplemented, where appropriate, by data relating to its positioning within this same rack, and possibly an identification code for a storage cabinet of this same rack.

In this context, the present applicant has noted that the various existing models of racks for vials and/or cryotubes of biological samples are not fully satisfactory, insofar as they do not allow automation of the above-mentioned operations, which are necessary for the traceability of the vials and cryotubes.

In fact, due to their structure in the form of simple bins or to the arrangement of the individual housings along an axis perpendicular to the base, the encoded data affixed to the outer wall of the vials and cryotubes are only perfectly visible, and therefore can only be read, by manually extracting the vials and cryotubes one after the other from the rack or their respective housings, before replacing them there. In other words, conventional racks do not allow automated reading, in a single step, and therefore simultaneously, of a rack's identification code, of the respective encoded identification data of all the vials and/or cryotubes, and of their respective location data on the same rack, with a view to associated recording of these data in a database.

On the contrary, with existing racks, numerous successive manipulations of vials and cryotubes are required to carry out these operations, which is particularly time-consuming, and further raises a significant risk of loss of biological material during hasty handling of vials and/or cryotubes, which are sometimes poorly resealed or slip out of the operators' hands. In addition, it has been observed that after being extracted for manual reading of their identification code, some vials and/or cryotubes are mistakenly repositioned in a rack other than their original one. This generates errors in the databases, which can later result in analyses being carried out on the wrong sample, and hence diagnoses being attributed to the wrong patient, or in samples that have not yet been diagnosed being discarded prematurely.

Moreover, most conventional racks have the disadvantage of being bulky and therefore taking up considerable storage space, which means extra costs.

### BRIEF SUMMARY OF THE INVENTION

The aim of the present invention is to propose a new type of rack for biological sample vials and/or cryotubes, designed to overcome the above-mentioned problems.

More precisely, the rack according to the invention has been specifically designed to enable automated reading, in one single step, of an identification code it comprises, of the respective encoded identification data of all the vials and/or cryotubes it contains, and of the respective location data of said vials and/or cryotubes on the same rack. The rack according to the invention has also been designed to offer a compact, space-saving, easy-to-store structure, suitable for the various standard formats of existing vials and/or cryotubes, and with which the risk of loss of biological material is greatly reduced, or even eliminated.

To this end, the present invention relates to a rack of the type indicated in the preamble, characterized in that it comprises a base connected to the peripheral wall, while the axis X of said housings forms an angle α of between 30° and 50° with said base.

Furthermore, depending on the case, the rack according to the invention may also have one or more of the following features:
the hollow face of the side wall of said housings has a curved cross-section.
said housings are bordered by a plurality of wings of thickness e, extending parallel to the axis X.
the housings are formed along said at least one row in such a way that their axes X are equidistant.
the rack comprises a plurality of rows of housings, extending parallel to one another and spaced apart by a distance d.
the housings are formed along the rows so as to be aligned with one another from one row to the next.
the housings are formed along the rows so as to extend staggered from one row to the next.
the base of the rack and/or its peripheral wall comprise means suitable for stacking.
the stacking means comprise male and female means formed respectively on the upper edge of the peripheral wall and the outer face of its base, or vice versa.
the upper edge of its peripheral wall has an area suitable for receiving an identification code.

### BRIEF DESCRIPTION OF THE SEVERAL VIEWS OF THE DRAWINGS

The attached drawings show the invention.

FIG. 1 shows a perspective view of an example of a rack according to the invention, suitable for storing twenty vials and/or cryotubes of biological samples, in an empty state.

FIG. 2 is a perspective view of another embodiment of the rack according to the invention, suitable for storing twenty vials and/or cryotubes of biological samples, with the rack in a filled state.

FIG. 3 corresponds to a top view of another embodiment of the rack according to the invention, suitable for storing forty-five vials and/or cryotubes of biological samples, the rack being in a filled state.

FIG. 4 shows a top view of another embodiment of the rack according to the invention, suitable for storing eighty vials and/or cryotubes of biological samples, with the rack in a filled state.

### DETAILED DESCRIPTION OF THE INVENTION

As noted above, the present invention relates to a rack 1, 10, 100, 101 for vials and/or cryotubes 2, 20, 200 of biological samples. In the variant embodiments shown, it is made of plastic. However, any other material with equivalent properties can also be considered for its manufacture.

With reference to the drawings, the rack 1, 10, 100, 101 comprises a base 3 provided with a peripheral wall 4, the upper edge 5 of which defines an access opening 50 providing access to the internal volume of the rack 1, 10, 100, 101. As can be seen from the figures, in the variants shown, the upper edge 5 has a recess 16 advantageously defining an area suitable for receiving an identification code specific to each rack 1, 10, 100, 101 used to store vials and/or cryotubes 2, 20, 200. In addition, the base 3 of the rack 1, 10, 100 supports several rows 6, featuring a plurality of housings 7 of axis X, each suitable for accommodating a biological sample vial or cryotube 2, 20, 200.

In this respect, it should be noted that the vials and cryotubes 2, 20, 200 are not part of the invention, and correspond to laboratory accessories well known to the skilled person. Traditionally cylindrical in shape and fitted with a lid, they are currently marketed in several standard formats, suitable for accommodating fluids or tissue samples of varying sizes. In short, the vials and/or cryotubes referenced 2, 20, 200 in the figures correspond to standard vials and/or cryotubes commonly used in laboratories today, with vials and/or cryotubes 20 having a volume greater than that of vials and/or cryotubes 2, 200, while vials and/or cryotubes 200 have a conical-shaped base. Furthermore, as can be seen from the figures, the vials and/or cryotubes 2, 20, 200 shown are conventionally fitted with self-adhesive labels bearing their respective encoded identification data 15.

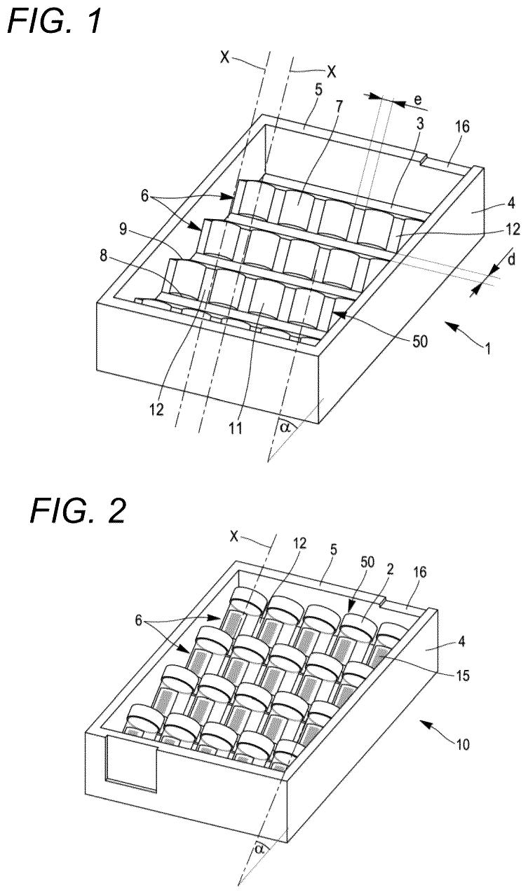

As shown in FIG. 1, each housing 7 of the rack 1, 10, 100, 101 is delimited by a lower face 8, perpendicular to the axis X, surmounted by a side wall 9. It should be noted that the lower face 8 is designed to be flat, but may have any other shape, such as a cone, to facilitate perfect positioning of a vial and/or cryotube 2, 20, 200 within a housing 7. Similarly, in accordance with the invention, the appearance of the lower face 8 may differ from one housing 7 to another. Thus, for example, for the same rack 1, 10, 100, 101, some housings 7 may have a flat lower face 8, while other housings may have a conical lower face or any other shape adapted to the shape of the base of a commercial biological sample vial or cryotube. In accordance with the invention, the side wall 9 has a hollow face 11 oriented toward the access opening 50 to the internal volume of the rack 1, 10, 100, 101, while the axis X of each housing forms an angle α, of between 30° and 50°, with the base 3.

It should also be noted that, in the embodiments shown, the hollow face 11 of the side wall 9 of the various housings 7 has a curved cross-section for optimal wedging and accommodation of cylindrical biological sample vials and/or cryotubes of conventional format, such as vials and/or cryotubes 2, 200, as well as larger-volume vials and/or cryotubes 20.

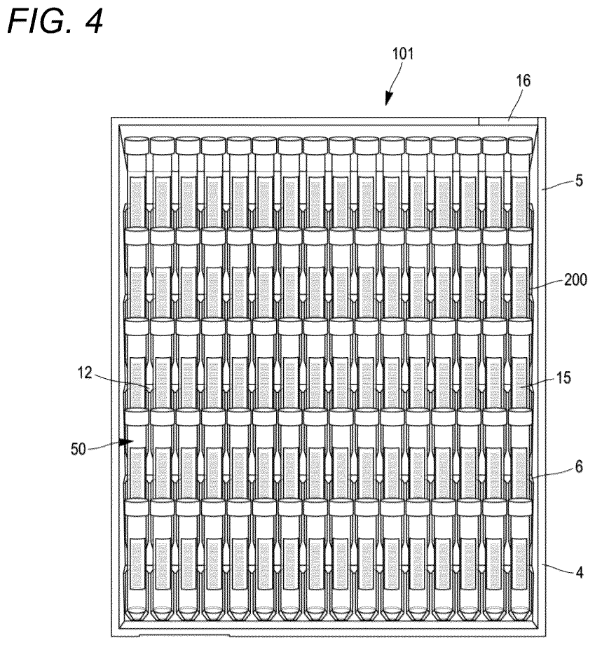

Moreover, in the various embodiments shown in FIGS. 1 to 4, the various rows 6 of housings 7 run parallel to one another and are advantageously spaced apart by a distance d.

The housings 7 are formed along the various rows 6 in such a way that their axes X are equidistant. They are also bordered by a plurality of wings 12, of thickness e, extending parallel to the axis X. The presence of the wings 12 and the distance d provided between two adjacent rows 6 make it possible to provide sufficient spacing between the vials and/or cryotubes 2, 20, 200 contained in the rack 1, 10, 100, 101, to avoid errors in reading the encoded identification data 15 they contain, by an automatic or manual reading device. The presence of the wings 12 further ensures that the vials and/or cryotubes 2, 20, 200 do not come into contact with one another, thus preventing any collisions that could lead to unwanted cracking.

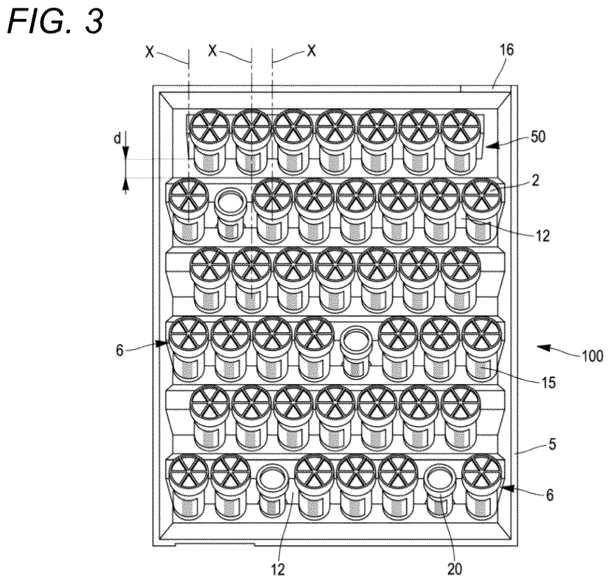

In accordance with a further feature of the invention, the housings 7 are arranged along the various rows 6 in such a way that the housings of one row are aligned with those of the other rows 6 (cf. FIG. 1, 2 and 4), or in such a way that they are staggered from one row 6 to another (see FIG. 3).

As part of the present invention, the base 3 and/or the peripheral wall 4 of the rack 1, 10, 100, 101 are also fitted with means suitable for stacking, such as male and female means formed respectively on the upper edge of the peripheral wall and the outer face of its base, or vice versa.

Finally, it is clear from the above that the objectives described in the preamble are achieved owing to the above-mentioned features of the rack 1, 10, 100, 101.

Indeed, once the vials and/or cryotubes 2, 20, 200 are placed in said rack, they rest on the flat, conical or otherwise shaped lower face 8 and the hollow face 11 of their respective housings 7. The vials and/or cryotubes 2, 20, 200 are then inclined at an angle α, for example equal to 40°, with respect to the base 3 of the rack 1, 10, 100, 101.

In such a configuration, any spillage or leakage of their contents is prevented.

In addition, the vials and/or cryotubes 2, 20, 200 are located side by side in the same rack 1, 10, 100, 101, without overlapping. It is therefore sufficient to arrange them in such a way that the encoded identification data 15 they contain are all oriented in the direction of the access opening 50 to the internal volume of the rack 1, 10, 100, 101 to enable all of them to be read automatically in a single step, as well as a determination of the positioning data of the vials and/or cryotubes 2, 20, 200 within the rack 1, 10, 100, 101 and a reading of the identification code of the rack 1, 10, 100, 101 present on the recess 16 of the upper edge 5 of the latter. It should be noted that such reading can be carried out by appropriate reading means well known to the skilled person, such as a camera, a light scanner or any other equivalent means, connected to computer processing means also well known to the skilled person.

In short, the particular structure of the rack 1, 10, 100, 101 according to the invention has the advantage of giving each vial and/or cryotube contained therein a unique position, reliably detectable with all the automatic reading means currently available to the skilled person. The angle of inclination of the housings 7, between 30° and 50°, ensures that the identification codes of the vials and/or cryotubes cannot be misread, and prevents any loss of biological material due to possible spillage of vials or cryotubes. In addition, the rack according to the invention can be marketed in the form of a range of different sizes, comprising more or fewer housings 7, aligned with one another or staggered from one row to another, whose side wall and base are identical in shape and size for all the housings in the same rack, or differ from one housing to another in the same rack. It also perfectly meets the diverse needs of analysis laboratories for managing vials and/or cryotubes of biological samples.

1. A rack for biological sample vials and/or cryotubes, comprising:
a peripheral wall whose upper edge defines an access opening to the internal volume of the rack,
at least one row of housings of axis X extending inside the internal volume, each housing being suitable for a biological sample vial or cryotube, said housings being delimited by a lower face, perpendicular to the axis X, surmounted by a side wall having a hollow face oriented toward the access opening to the internal volume, and
a base connected to the peripheral wall,
wherein the axis X of said housings an angle α of between 30° and 50° with said base.

2. The rack, according to claim 1, wherein a hollow face of the side wall of said housings has a curved cross-section.

3. The rack, according to claim 1, wherein said housings are bordered by a plurality of wings, of thickness e, extending parallel to the axis X.

4. The rack, according to claim 1, wherein the housings are formed along said at least one row in such a way that their axes X are equidistant.

5. The rack, according to claim 1, further comprising: a plurality of rows of housings, extending parallel to one another and spaced apart by a distance d.

6. The rack, according to claim 1, wherein the housings are formed along the rows so as to be aligned with one another from one row to another.

7. The rack, according to claim 1, wherein the housings are formed along the rows so as to be staggered relative to one another from one row to another.

8. The rack, according to claim 1, wherein the base and/or its peripheral wall comprise means suitable for allowing stacking.

9. The rack, according to claim 8, wherein the stacking means comprise male and female means formed respectively on the upper edge of the peripheral wall and the outer face of its base, or vice versa.

10. The rack, according to claim 1, wherein the upper edge of its peripheral wall has an area suitable for receiving an identification code.
